(19) United States
(12) Patent Application Publication
(10) Pub. No.: US 2011/0008097 A1
(43) Pub. Date: Jan. 13, 2011

(54) RETAINING ASSEMBLY OF BINDER

(76) Inventor: HSUEH-CHIH SHIH, ZHONGHE (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/824,282

(22) Filed: Jun. 28, 2010

(30) Foreign Application Priority Data
Jul. 7, 2009 (TW) 098212392
Nov. 27, 2009 (TW) 098222328

(51) Int. Cl. B42F 13/20; B42F 13/00

(52) U.S. Cl. 402/31; 402/73

(57) ABSTRACT

A retaining assembly of a binder comprises a layering and a lodging body. Two sides of the layering are provided with a clip notch respectively. The lodging body is lodged to the layering. The lodging body has connection pieces, hooks and hook pieces. The connection pieces are connected to the hooks. The connection piece is formed by bending one end of the hook to reach an angle. The hook piece is formed by bending another end of the hook to reach the angle. Since the hook pieces pass through the through holes of the loose leaf binder, the through holes are fit to the hooks. Afterward, when the connection pieces and the hook pieces are lodged in the corresponding clip notches, the loose leaf binder is positioned on the lodging body.

### BACKGROUND OF THE INVENTION

1. Field of the Invention

The present invention relates to a binder, and more particularly to a retaining assembly of the binder.

2. Description of the Related Art

A structural improvement for a conventional loose leaf binder disclosed in Taiwan (Republic of China) patent gazette publication No. 456325 mainly utilizes a single set of loose leaf binder (which is composed of a plurality of hooks) to combine with a single set of barrier to provide a device for passing through loose leaves.

However, the foregoing conventional loose leaf binder still has the following defects under the actual use application. Since the length of the barrier is identical to the length of a notebook, and since a specification of the length of the notebook is diversity, operators must develop many barriers with different lengths to satisfy the notebooks having various specifications, resulting in consuming resources and increasing cost. Moreover, the single loose leaf binder equipped with loose leaves is composed of a plurality of integrated hooks. To satisfy the notebook with different lengths and sizes, the loose leaf binder having many sizes and lengths must be developed. Actually, people who use the conventional loose leaf binder usually accept standard loose leaf binders with the same types, the same sizes or the same hole number. The conventional loose leaf binder can be automatically mounted by relying upon mechanical appliances, and the barrier and the loose leaf binder are restricted by the material specification. In fact, the side of the loose leaf binder does not need to fully deploy through holes and does need to install the barrier having the same size and length to save the resource.

The structural improvement for the conventional loose leaf binder usually takes the binder as a main issue for improvement. However, people always disregarded that the loose leaves also need to be protected. Consequently, users' demand may not be completely satisfied by the convention loose leaf binder.

### SUMMARY OF THE INVENTION

In view of the shortcomings of the prior art, the inventor of the present invention based on years of experience in the related industry to conduct extensive researches and experiments, and finally developed a retaining assembly of a binder so that loose leaves disposed on a lodging body is positioned by lodging the lodging body on a layering, and the loose leaves can be protected by a front cover.

Therefore, a primary object of the present invention is to overcome the aforementioned shortcoming and deficiency of the prior art by providing a retaining assembly of a binder.

To achieve the foregoing object, the retaining assembly of a binder comprises a layering and a lodging body. Two sides of the layering are provided with a clip notch respectively. The lodging body corresponds to the layering. The lodging body comprises a connection piece, a plurality of hooks and a plurality of hook pieces. The connection piece is connected to the plurality of hooks. The connection piece is formed by bending one end of each hook to reach an angle. The hook piece is formed by bending another end of the hook to reach the angle. An equal distance between one side of the hook and the same side of another adjoined hook is about 5 millimeter to 8.9 millimeter, about 8.9 millimeter to 9.8 millimeter, or about 9.8 millimeter to 1000 millimeter. Since the hook pieces pass through the through holes of the plurality of loose leaf binders, the through holes can be fit with the hooks. Afterward, when the connection piece and the hook pieces are lodged in the corresponding clip notches, the loose leaf binders are respectively positioned to the lodging bodies.

Further, a second objective of the present invention is to provide a retaining assembly of a binder, which comprising a layering and a plurality of lodging bodies. The layering comprises a plurality of guide rails. Two sides of each guide rail are provided with a clip notch respectively. One guide rail and another adjoined guide rail are arranged to keep abreast with each other. The plurality of lodging bodies are lodged on the layering. The lodging body comprises a connection piece, a plurality of hooks and a plurality of hook pieces. The connection piece is connected to the plurality of hooks, and the connection piece is formed by bending one end of the plurality of hooks to reach an angle. Each hook piece is formed by bending another end of each hook to reach the angle. An equal distance between one side of the hook and the same side of the adjoined hook is about 5 millimeter to 8.9 millimeter, about 8.9 millimeter to 9.8 millimeter, or about 9.8 millimeter to 1000 millimeter. Since each hook piece respectively passes through a plurality of through holes of a plurality of loose leaf binders, the plurality of through holes can be respectively fit to each hook. When the connection piece and the hook pieces are lodged in the corresponding clip notches, a plurality of loose leaf binders can be positioned to the plurality of lodging bodies respectively.

In addition, the third object of the present invention is to provide a retaining assembly of a binder, which comprising a front cover structure and at least one lodging body. The front cover structure comprises a layering and a covering portion. The layering is disposed on a surface of the covering portion. The lodging body is lodged on the layering, and the lodging body comprises a connection piece, a plurality of hooks and a plurality of hook pieces. The connection piece is connected to the plurality of hooks. The connection piece is formed by bending one end of the plurality of hooks to reach an angle. The hook piece is formed by bending another end of each hook to reach the same angle. A side of the hook and a side of another adjoined hook are spaced at an equal interval. The plurality of hook pieces and the connection piece are at the same horizontal plane. The covering portion is bent toward directions of the layering and the lodging body along two sides of the lodging body lodged to the layering.

The structure further comprises a plurality of loose leaves. Since each hook piece passes through a plurality of through holes of plurality of loose leaves, the plurality of through holes are respectively fit to each hook. When the connection piece and the hook pieces are lodged on the corresponding layerings, the plurality of loose leaves is positioned on the lodging body, and the covering portion covers the layerings, the lodging body and the plurality of loose leaves.

The retaining assembly of a binder in accordance with the present invention has one or more advantages as the following:
(1) The retaining assembly of a binder can cut the layering itself, and the Do-It-Yourself manner can be suitable for loose leaf binders with different lengths and sizes.
(2) The distance of the retaining assembly of a binder between adjacent hooks matches the international standard of hole distances of ordinary loose leaves and loose leaf binders. Thus, each loose leaf and the loose leaf binder can be installed on users' demands.
(3) The retaining assembly of a binder can overcome the defect that the conventional technique always relies on a machine to punch and perform book binding. Accordingly, the numbers of the hole and the net weight of the binder can be reduced to further save expenses of material development, book binding and hole punching, thereby decreasing the consumable cost.
(4) The retaining assembly of a binder can properly protect loose leaves. The loose leaves may not be dirtied or damaged to increase the utilization and conservation span of the loose leaves.

### BRIEF DESCRIPTION OF THE DRAWINGS

FIG. 1 is a decomposition drawing of a retaining assembly of a binder in accordance with the first embodiment of the present invention;

FIG. 2 is an assembly drawing of a retaining assembly of a binder in accordance with the first embodiment of the present invention;

FIG. 3 is an appearance figure of a retaining assembly of a binder in accordance with the first embodiment of the present invention;

FIG. 4 is an enlarged diagram of partial components of an assembly type retaining structure in accordance with the first embodiment of the present invention;

FIG. 5 is an appearance figure of a retaining assembly of a binder in accordance with the second embodiment of the present invention;

FIG. 6 is an appearance figure of a retaining assembly of a binder in accordance with the third embodiment of the present invention;

FIG. 7 is an appearance figure of a retaining assembly of a binder in accordance with the fourth embodiment of the present invention;

FIG. 8 is an appearance figure of a retaining assembly of a binder in accordance with the fifth embodiment of the present invention;

FIG. 9 is a decomposition drawing of a retaining assembly of a binder in accordance with the sixth embodiment of the present invention;

FIG. 10 is a cross-sectional drawing of a clip notch of a retaining assembly of a binder in accordance with the sixth embodiment of the present invention;

FIG. 11 is a cross-sectional drawing of a lodging slot of a retaining assembly of a binder in accordance with the sixth embodiment of the present invention;

FIG. 12 is an appearance figure of a retaining assembly of a binder in accordance with the seventh embodiment of the present invention;

FIG. 13 is an appearance figure of a retaining assembly of a binder in accordance with the eighth embodiment of the present invention;

FIG. 14 is an appearance figure of a retaining assembly of a binder in accordance with the ninth embodiment of the present invention;

FIG. 15 is an appearance figure of a retaining assembly of a binder in accordance with the tenth embodiment of the present invention; and

FIG. 16 is a side view drawing of a retaining assembly of a binder in accordance with the tenth embodiment of the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

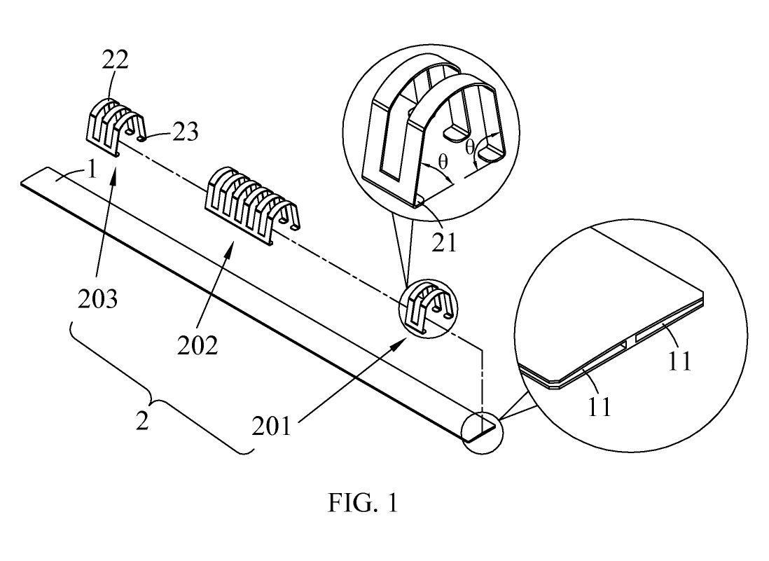

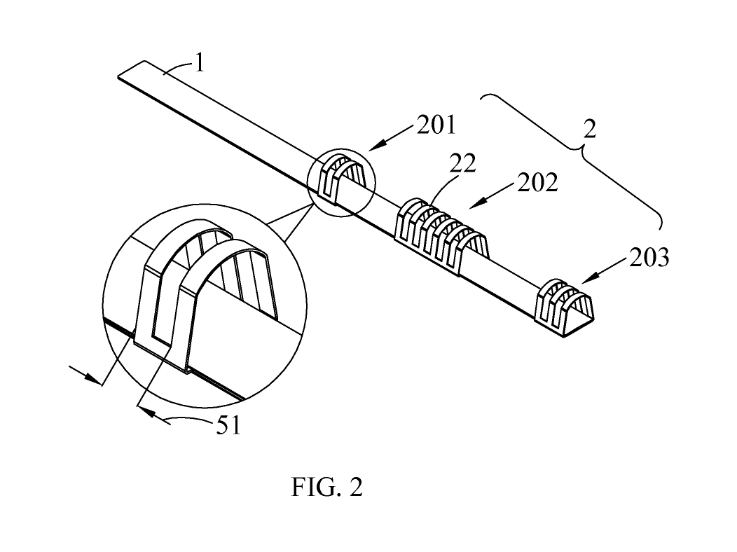

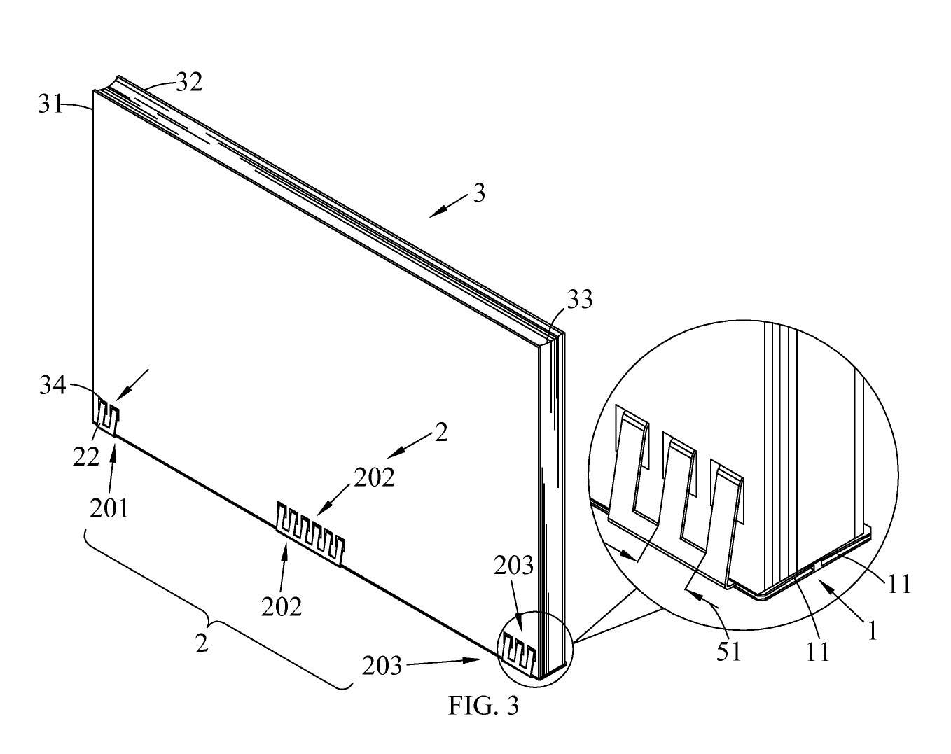

Please refer to FIG. 1 to FIG. 3, which are a decomposition drawing of a retaining assembly of a binder in accordance with the first embodiment, an assembly drawing of a retaining assembly of a binder in accordance with the first embodiment, and an appearance figure of a retaining assembly of a binder in accordance with the first embodiment respectively. In FIG. 1 to FIG. 3, the binder 3 may comprise a front cover 31, a back cover 32 and a plurality of loose leaves 33 based on demands, and the loose leaves 33 are disposed between the front cover 31 and the back cover 32. One side of the front cover 31, the back cover 32 and the loose leaves 33 has a plurality of through holes 34. In the first embodiment, the through holes 34 are, but are not limit to, rectangular through holes and may also be circular through holes or ellipse through holes. The hole distance between two of the adjoined through hole 34 complys with international standards.

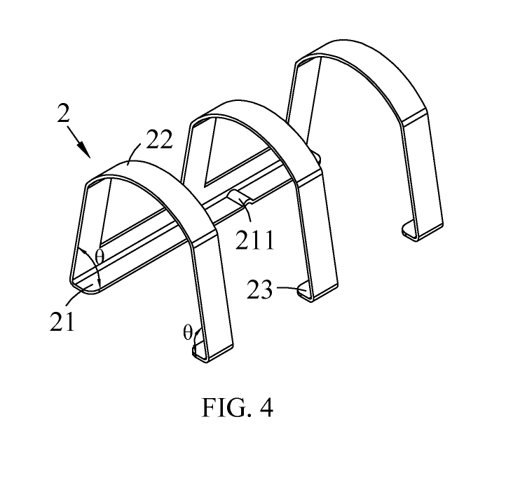

The retaining assembly of a binder 3 comprises a layering 1 and at least one lodging body 2. The layering 1 is a strip having a lath shape. An outer surface of the layering is an arc surface while an inner surface is a plane. Two sides of the layering 1 are provided with a clip notch 11 respectively, wherein the material of the layering 1 may be soft materials (e.g. water-proof cloths, non-woven fabric or papers), hardness materials (e.g. sandwich panels, woods or bamboos), leather materials (e.g. natural leathers or artificial leathers), metal materials (e.g. aluminum alloy or ferrous alloy) or plastic materials formed by sewing or adhesion. In the first embodiment, a user or an operator can cut proper lengths and sizes thereof through Do-It-Yourself on demands. The lodging body 2 corresponds to the layering 1. The lodging body 2 has a connection piece 21, a plurality of hooks 22 and a plurality of hook pieces 23. The connection piece 21 is extended from the hooks 22 and formed by bending an end of the hook 22 toward an inner side of the hook 22 to form an angle θ, and the angle θ is approximately ninety degrees. Please refer to FIG. 4, which is an enlarged diagram of partial components of a retaining assembly in accordance with the first embodiment. As shown in FIG. 4, the connection piece 21 may have a bump 211. The lodging body 2 may be positioned to the layering 1 through the bump 211 lodged in the clip notch 11. The foregoing lodging body 2 includes a first lodging body 201, a second lodging body 202, and a third lodging body 203. The first lodging body 201, the second lodging body 202 and the third lodging body 203 may have different number of the hooks 22.

The hook piece 23 is formed by bending another end of each hook 22 toward the inner side of the hook 22 to form an angle θ, and the angle θ is approximately ninety degrees. A distance 51 between one side of two of the adjoined hook 22 is about 5 millimeter to 8.9 millimeter, about 8.9 millimeter to 9.8 millimeter, or about 9.8 millimeter to 1000 millimeter. The distance between one side of two of the adjoined hook 22 complys with the international standards of the ordinary loose leaf binder or the loose leaves 33 and allows the user to conveniently punch holes by themselves or easily purchase the loose leaves 33 having standard through holes 34 from vendors.

By passing the foregoing hook pieces 23 through the through holes 34 of the binder 3, the through holes 34 correspond to and are set through each hook 22. Afterward, when the connection piece 21 and the hook pieces 23 are lodged in the corresponding clip notches 11, and the loose leaf binder 3 is positioned to the lodging body 2. Additionally, in the present embodiment, the different lodging bodies 2 lodged on the layering 1 may be three lodging bodies 2 installed two hooks 22, three hooks 22 and six hooks 22 as desired so as to be positioned on the layering 1. However, the first embodiment does not limit to have the two hooks 22, the three hooks 22 and the six hooks 22 of the three lodging bodies 2 and may have a single or a plurality of lodging bodies 2 having the same number of the hooks 22 positioned on the layering 1 or may be the lodging body 2 beyond the number of the foregoing hooks 22 positioned to the layering 1 or may be different numbers of lodging bodies 2 such as a single lodging body 2, two lodging bodies 2, four lodging bodies 2 or five lodging bodies 2 that are positioned to the layering 1.

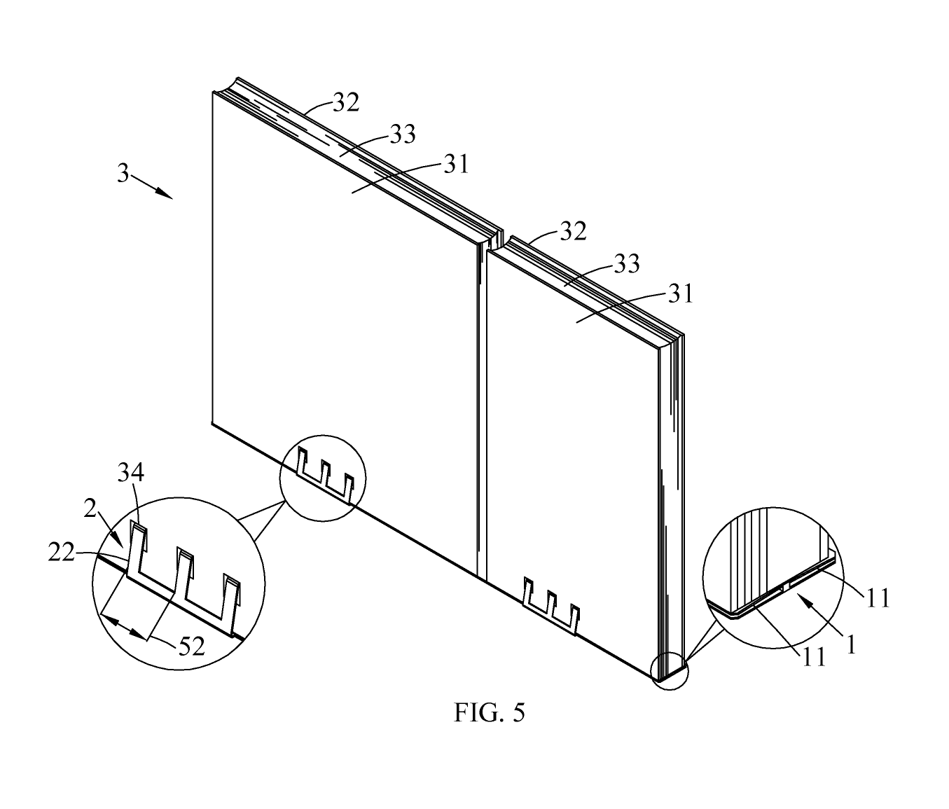

Please refer to FIG. 5, which is an appearance figure of a retaining assembly of a binder in accordance with a second embodiment of the present invention. The retaining assembly in accordance with the second embodiment of the present invention is similar to to the first embodiment. Therefore, with reference to FIG. 1, the difference between the first and the second embodiment is that the distance between one side of two of the adjoined hooks in the second embodiment differs from that of the first embodiment. The same detail descriptions are omitted. In FIG. 5, the distance 52 between one side of two of the adjoined hook 22 is about 8.9 millimeter to 9.8 millimeter.

Since the hook pieces 23 pass through the through holes 34 of a binder 3, the through holes 34 are disposed through each hook 22. Afterward, when the connection piece 21 and the hook pieces 23 are lodged in the corresponding clip notches 11, the binder 3 is positioned to the lodging body 2. Additionally, in the second embodiment, the number of the binder 3 may be more than one. Each front cover 31, each back cover 32 or the plurality of loose leaves 33 have, but does not limit to, different sizes and each front cover 31, each back cover 32 or the plurality of loose leaves 33 may also have the same sizes. The number of the hooks 22 of the lodging body 2 may be increased or decreased in accordance with the size of the binder 3. The two lodging bodies 2 lodged on the layering 1 may be installed with the two lodging bodies 2 having three hooks 22 positioned to the layering 1 on the user's demand. However, the two lodging bodies 2 does not limit to have the three hooks 2 and may also have different number of the hooks 22 positioned to the layering 1. Alternatively, it can also provide different number of lodging bodies 2, such as a single lodging body 2, three lodging bodies 2, four lodging bodies 2 or five lodging bodies 2, positioned on the layering 1.

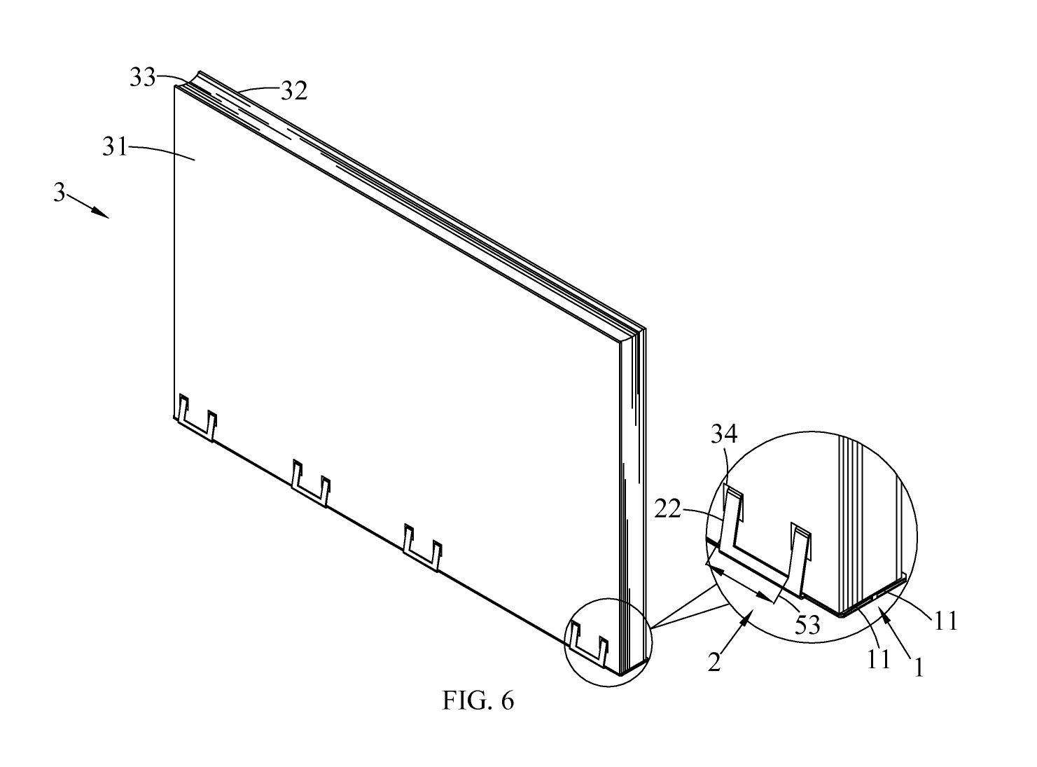

Please refer to FIG. 6, which is an appearance figure of a retaining assembly of a binder in accordance with the third embodiment of the present invention. The retaining assembly in accordance with the third embodiment of the present invention is similar to to the first embodiment. Therefore, with reference to FIG. 1, the difference between the first and third embodiment is that the distance between one side of two adjoined hooks differs from a distance between that of the first embodiment. The same detail descriptions are omitted herein. In FIG. 6, the distance 53 between one side of the two adjoined hook 22 is about 9.8 millimeter to 10.8 millimeter.

By passing the hook pieces 23 through the through holes 34 of a binder 3, the through holes 34 are disposed through each hook 22. Afterward, when the connection piece 21 and the hook pieces 23 are lodged in the corresponding clip notches 11, the binder 3 is positioned to the lodging body 2. Additionally, in the third embodiment, the four lodging bodies 2 lodged on the layering 1 may be installed by the user to have two hooks 22 positioned to the layering 1. However, the four lodging bodies 2 does not limit to have the two hooks 22 and may have different number of the hooks 22 positioned on the layering 1. Alternatively, the lodging body 2 may be different number, such as a single lodging body 2, the two lodging bodies 2, the three lodging bodies 2 or five lodging bodies 2 positioned to the layering 1.

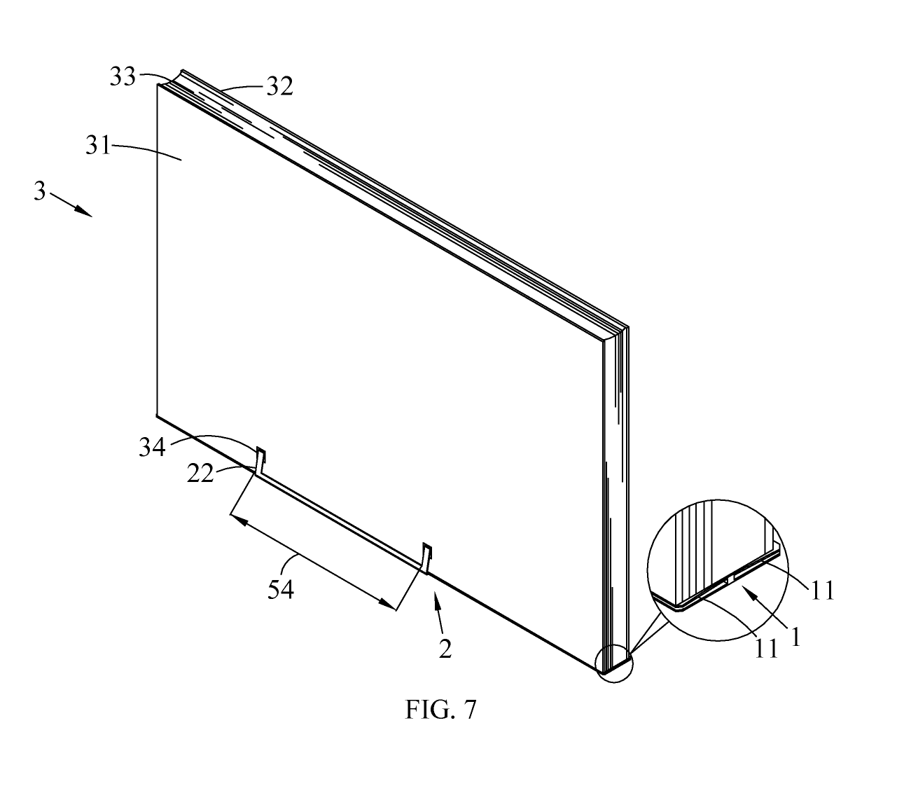

Please refer to FIG. 7, which is an appearance figure of a retaining assembly of a binder in accordance with the fourth embodiment of the present invention. The retaining assembly in accordance with the fourth embodiment of the present invention is similar to to the first embodiment. Therefore, with reference to FIG. 1, the difference between the first and the fourth embodiment is the distance between one side of the two adjoined hooks differs from that of the first embodiment. The same detail descriptions are omitted herein. In FIG. 7, the distance 54 between one side of the two adjoined hook 22 is about 10.8 millimeter to 1000 millimeter.

By passing the hook pieces 23 through the through holes 34 of a binder 3, the through holes 34 are disposed through each hook 22. Afterward, when the connection piece 21 and the hook pieces 23 are lodged in the corresponding clip notches 11, the binder 3 is positioned on the lodging body 2. Additionally, in the fourth embodiment, the single lodging body 2 lodged on the layering 1 may be installed by the user to have two hooks 22 positioned on the layering 1. However, the single lodging body 2 does not limit to have the two hooks 22 and may have different number of the hooks 22 positioned on the layering 1. Alternatively, the lodging body 2 may be different number, such as a single lodging body 2, the three lodging bodies 2, the four lodging bodies 2 or five lodging bodies 2 positioned to the layering 1.

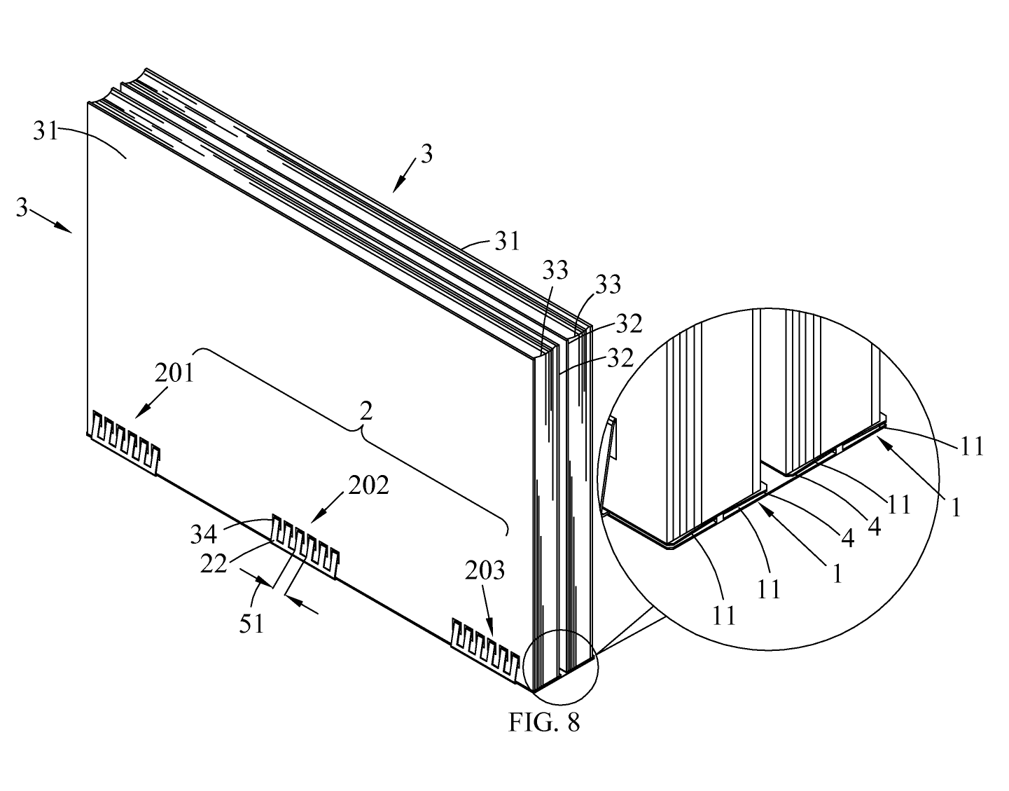

Please refer to FIG. 8, which is an appearance figure of a retaining assembly of a binder in accordance with the fifth embodiment of the present invention. The retaining assembly in accordance with the fifth embodiment of the present invention is similar to to the first embodiment. Therefore, with reference to FIG. 1, the difference between the first and the fifth embodiment is that the number and the shape of the layerings differ from that of the layering of the first embodiment when the layerings are arranged abreast. The number of the binder 3 is more than one. The same detail descriptions are omitted herein. In FIG. 8, the layering 1 has a plurality of guide rails 4. Two sides of each guide rail 4 are provided with a clip notch 11 respectively so that the guide rail 4 forms a T-shape. The guide rail 4 and an adjoined guide rail 4 are arranged abreast. By passing each hook piece 23 through of the corresponding through holes 34 of a plurality of binders 3 respectively, the plurality of through holes 34 are respectively disposed through each hook 22. When the connection piece 21 and the hook pieces 23 are lodged in the corresponding clip notches 11, the plurality of binders 3 are respectively positioned on the plurality of lodging bodies 2. The lodging body 2 includes a first lodging body 201, a second lodging body 202 and a third lodging body 203. The first lodging body 201, the second lodging body 202 and the third lodging body 203 have, but does not limit to, the same number of hooks 22 and also have different number of hooks 22.

Additionally, in the present embodiment, six lodging bodies 2 lodged on the two layerings 1 may be installed by user himself to have six hooks 22 positioned on the layerings 1. However, the six lodging bodies 2 does not limit to have the six hooks 22 may have different numbers of the hooks 22 positioned on the layerings 1. Alternatively, the lodging body 2 may be different number, such as a single lodging body 2, the two lodging bodies 2, the three lodging bodies 2, the four lodging bodies 2 or five lodging bodies 2 positioned on the layering 1

In the first embodiment to the fifth embodiment, the distance between one side of the adjoined hooks 22 is about 5 millimeter to 8.9 millimeter, about 8.9 millimeter to 9.8 millimeter, about 9.8 millimeter to 10.8 millimeter, and about 10.8 millimeter to 1000 millimeter respectively. However, the distance is not only applied to specific embodiment, and the distance between one side of the adjoined hooks 22 depicted in each embodiment may be about 5 millimeter to 8.9 millimeter, about 8.9 millimeter to 9.8 millimeter, or about 9.8 millimeter to 1000 millimeter.

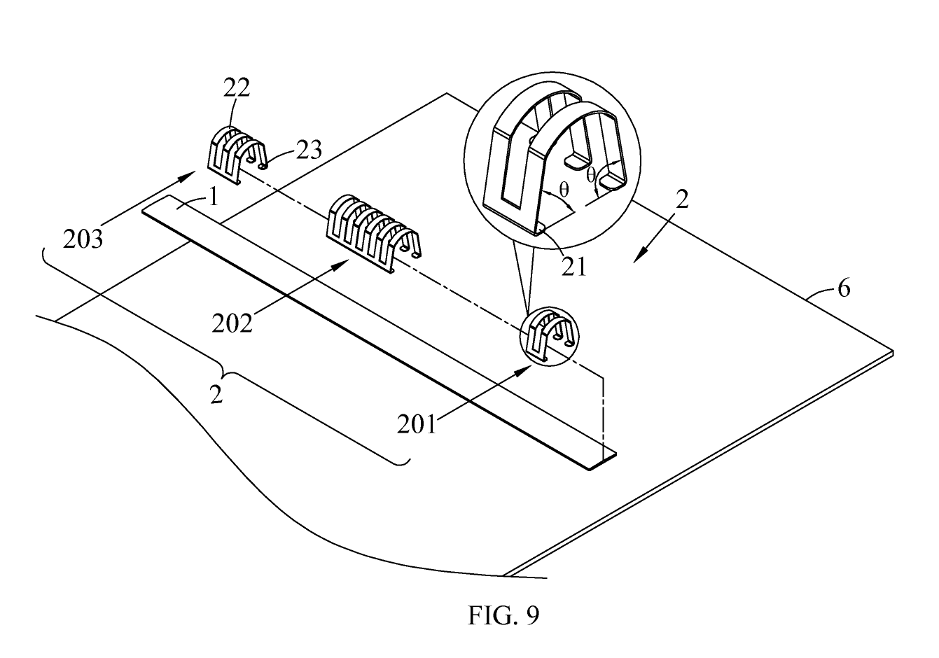

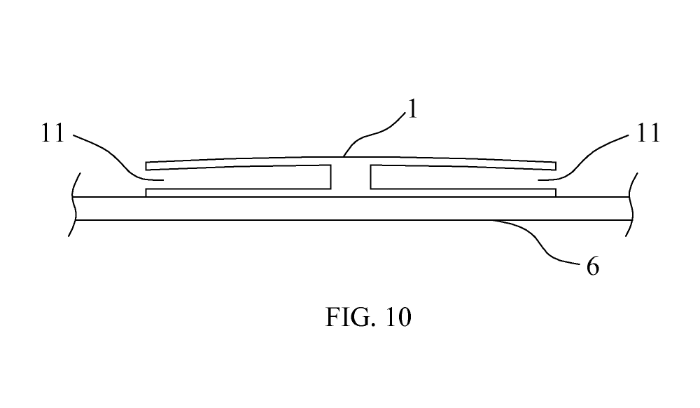

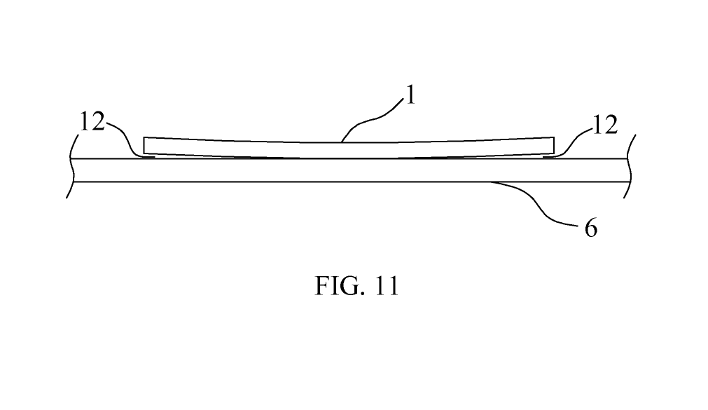

Please refer to FIG. 9 to FIG. 11, which are a decomposition drawing of an retaining assembly, a cross-sectional drawing of a clip notch, and a cross-sectional drawing of a lodging slot in accordance with the sixth embodiment respectively. In FIG. 9 to FIG. 11, the retaining assembly comprises a layering 1, at least one lodging body 2 and a covering portion 6. The layering 1 is disposed on a surface of the covering portion 6. The layering 1 may be a strip having a lath shape. An outer surface of the layering 1 is an arc surface while an inner surface is a plane. Two sides of the layering 1 may be provided with a clip notch 11 (as shown in FIG. 10) respectively. The layering 1 may be a sheet strip, and lodging slots 12 (as shown in FIG. 11) are respectively formed between two sides of the layering 1 and the covering portion 6. The material of the layering 1 may be soft materials (e.g. water-proof cloths, non-woven fabric or papers), hard materials (e.g. sandwich panels, woods or bamboos), leather materials (e.g. natural leathers or artificial leathers), metal materials (e.g. aluminum alloy or ferrous alloy), plastic materials or combination thereof. The layering 1 may be fastened on a surface of the covering portion 6 by adhesion, sewing, nailing or bolting.

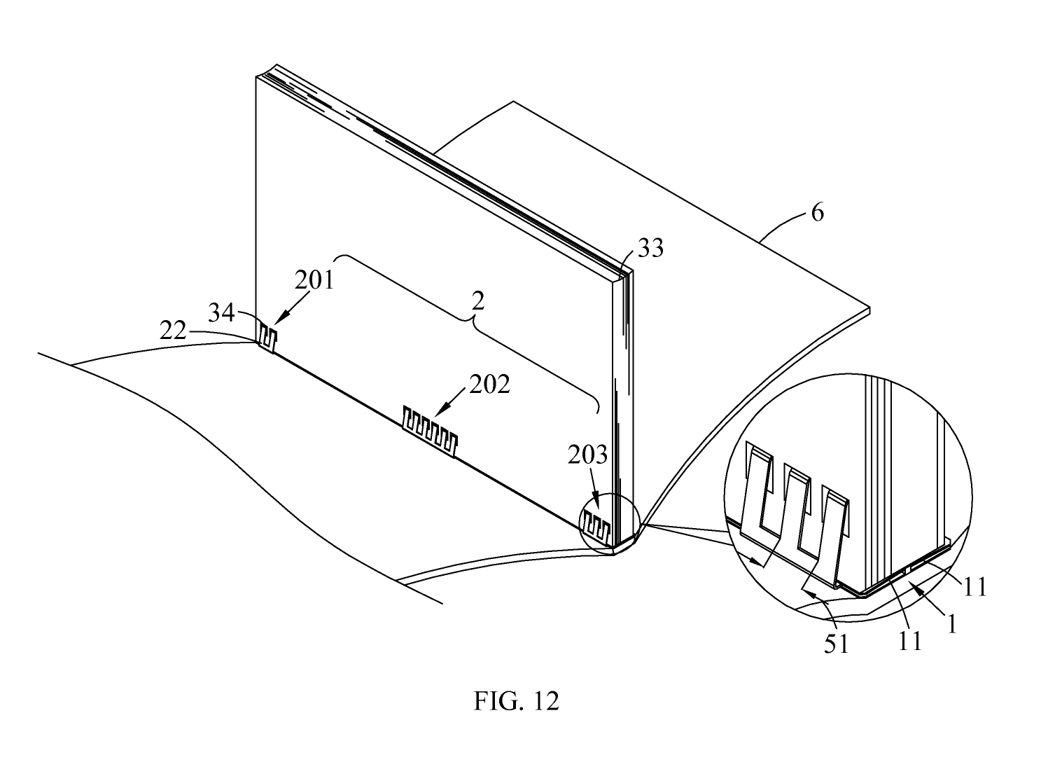

Please refer to FIG. 12, which is an appearance figure of a retaining assembly of a binder in accordance with the seventh embodiment. The retaining assembly in accordance with the seventh embodiment of the present invention is similar to the first embodiment and the same part is not depicted herein. However, in the seventh embodiment, a plurality of loose leaves 33 are further provided. One side of the loose leaves 33 comprises a plurality of through holes 34. In the seventh embodiment, the through holes 34 are, but are not limit to, rectangular through holes and may also be circular through holes or ellipse through holes. Further, hole distances between the adjoined through holes 34 comply with international standards.

In the seventh embodiment, the distance 51 between one side of the adjoined hooks 22 is about 5 millimeter to 8.9 millimeter, about 8.9 millimeter to 9.8 millimeter, about 9.8 millimeter to 10.8 millimeter, and about 10.8 millimeter to 1000 millimeter. The user or the operator can cut the layering to form proper lengths and sizes by themselves as desired.

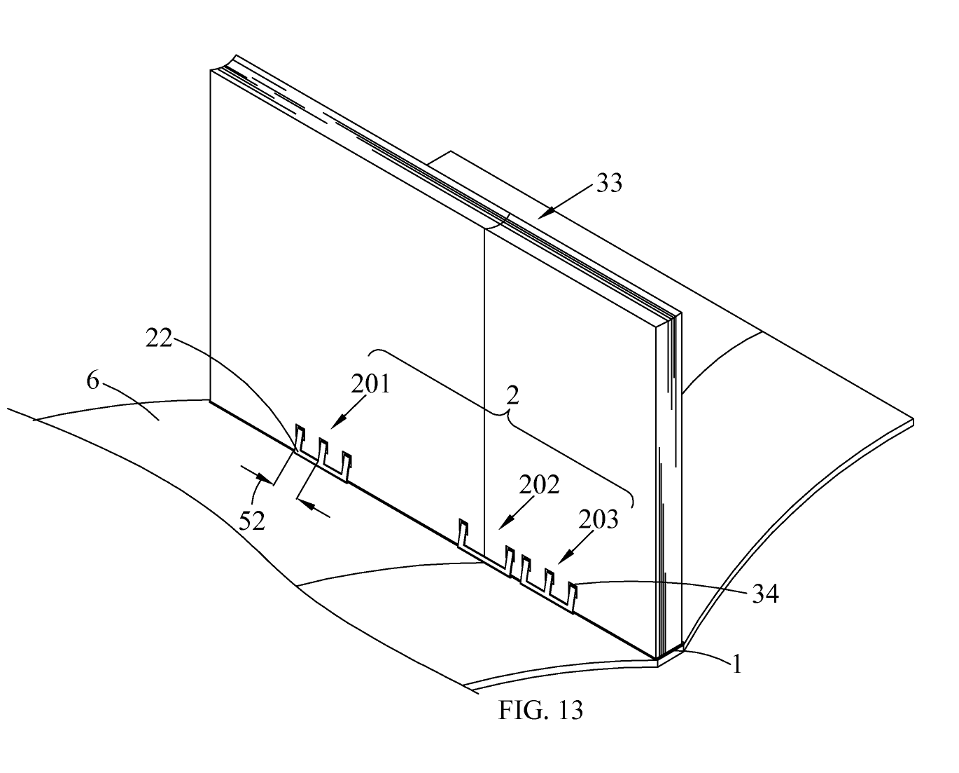

Please refer to FIG. 13, which is an appearance figure of a binder with a front cover in accordance with the eighth embodiment of the present invention. In FIG. 13, the retaining assembly in accordance with the eighth embodiment of the present invention is similar to to the sixth embodiment. Therefore, with reference to FIG. 9, the difference between the sixth and the eighth embodiment is the distance between one side of the adjoined hooks differs from that of the first embodiment. The same detail descriptions are omitted herein. In FIG. 13, the distance 52 between one side of the adjoined hooks 22 is about 8.9 millimeter to 9.8 millimeter.

By passing the hook pieces 23 through the through holes 34, the through holes 34 are disposed through each hook 22. Afterward, when the connection piece 21 and the hook pieces 23 are lodged on the corresponding clip notches 11, the loose leaves 33 are positioned on the lodging body 2. In addition, in the eighth embodiment, the number of the loose leave 33 may be more than one. Each covering portion 6 and each layering 1 have, but do not limit to, different sizes and may have the same size. Each layering 1 is connected to each other by passing the hook pieces 23 of a lodging body 2 respectively through the through holes 34 of each loose leaf 33, thus the through holes 34 of different loose leaves are disposed through the corresponding hook 22 of the same lodging body 2. Afterward, when the connection piece 21 and the hook piece 23 are lodged to the corresponding clip notches 11, the loose leaves 33 are positioned on the lodging body 2, and each layering 1 is connected to each other. Also, the number of the hooks 22 of the lodging body 2 may be increased or reduced in accordance with the sizes of the loose leaves 33 to conveniently collocate. The two lodging bodies 2 lodged on the layering 1 may be installed by the user to have three hooks 22 and thus be positioned on the layering 1. Different sets of the loose leaves 33 are respectively disposed through the two hooks 22. In FIG. 13, the distance 52 between one side of the adjoined hooks 22 is about 8.9 millimeter to 9.8 millimeter. However, the two lodging bodies 2 does not limit to have the three hooks 22 and may also have different number of the hooks 22 positioned on the layering 1. Alternatively, the lodging body 2 may be different number, such as a single lodging body 2, three lodging bodies 2, four lodging bodies 2 or five lodging bodies 2 positioned to the layering 1.

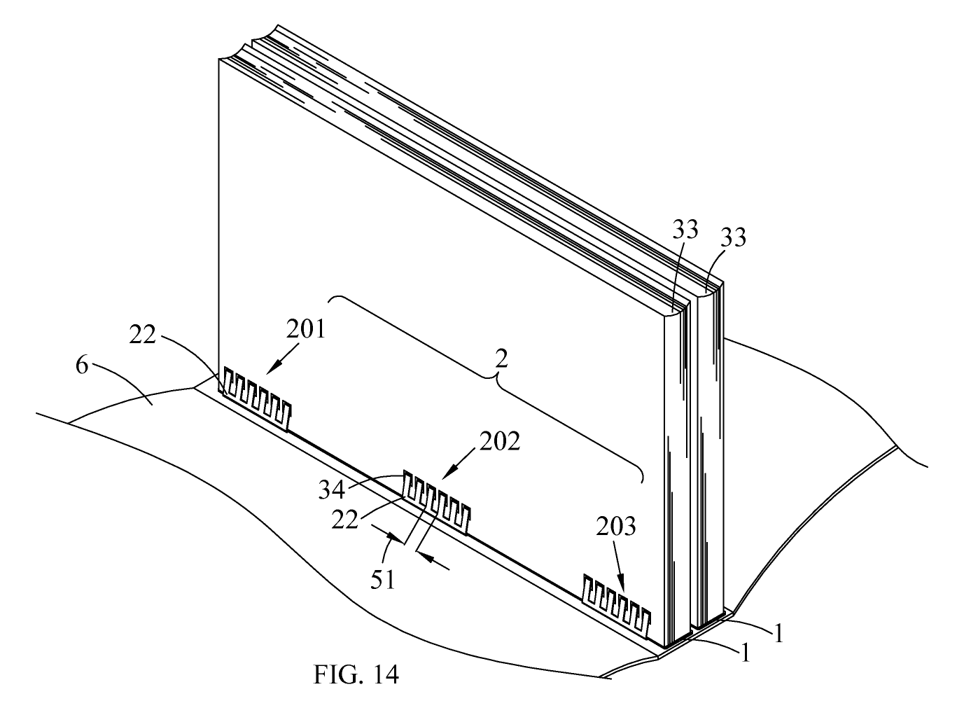

Please refer to FIG. 14, which is an appearance figure of a retaining assembly of a binder in accordance with the ninth embodiment of the present invention. The retaining assembly in accordance with the ninth embodiment of the present invention is similar to to the sixth embodiment. Therefore, with reference to FIG. 9, the difference is that the number and the shape of the layerings differ from that of the first embodiment when the layerings are arranged abreast. Also, the number of the loose leaf may be plural, and the same detail descriptions are omitted herein. In the FIG. 14, the plurality of layerings 1 are arranged abreast and fastened to the covering portion 6. The plurality of layerings can be fastened on a surface of the covering portion 6 by means of adhesion, sewing, nailing or bolting. By passing each hook piece 23 through a plurality of through holes 34 of a plurality of loose leaves 33, the plurality of through holes 34 are respectively disposed through each hook 22. When the connection piece 21 and the hook piece 23 are lodged to the corresponding clip notches 11, the plurality of loose leaves 33 are respectively positioned to the plurality of lodging bodies 2. The lodging bodies 2 may include a first lodging body 201, a second lodging body 202 and a third lodging body 203. The first lodging body 201, the second lodging body 202 and the third lodging body 203 includes, but does not limit to, the same number of the hooks 22 and may also have different number of the hooks 22.

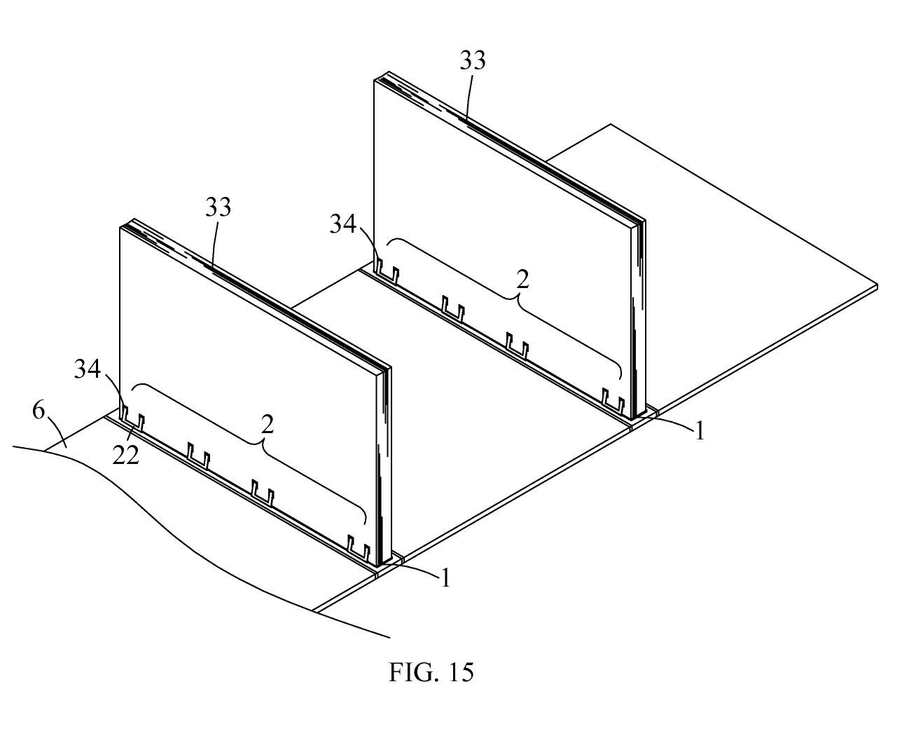

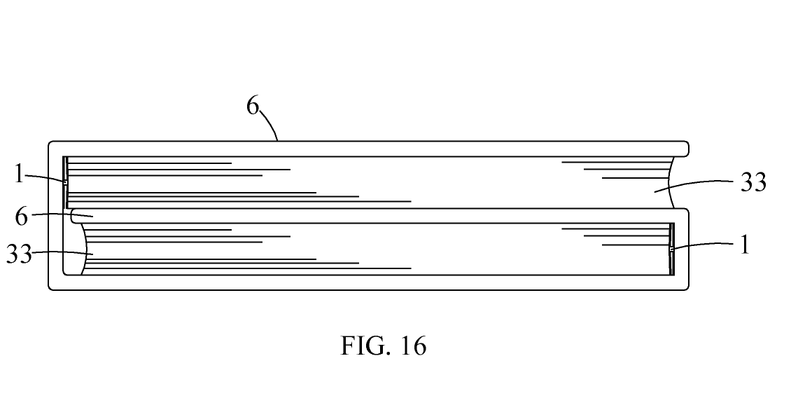

Please refer to FIG. 15, which is an appearance figure of a retaining assembly of a binder in accordance with the tenth embodiment of the present invention, the retaining assembly in accordance with the tenth embodiment of the present invention is similar to to the sixth embodiment. Therefore, with reference to FIG. 9, the difference therebetween is the number and shape of the layerings differs from that of the first embodiment when the layerings are arranged abreast. The number of the loose leaf may be plural, and the same detail descriptions are omitted herein. In FIG. 15, the plurality of layerings 1 are arranged abreast and fastened to the covering portion 6. The interval between the layerings 1 must be greater than the sum of the height of the plurality of loose leaves 33 and the width of one loose leave 33. The plurality of layerings 1 may be fastened on a surface of the covering portion 6 by means of adhesion, sewing, nailing or bolting. By passing each hook piece 23 through a plurality of through holes 34 of a plurality of loose leaves 33, the plurality of through holes 34 are respectively disposed through each hook 22. When the connection piece 21 and the hook pieces 23 are lodged to the corresponding clip notches 11, the plurality of binders 3 are respectively positioned to the plurality of lodging bodies 2. The lodging bodies 2 may include a first lodging body 201, a second lodging body 202 and a third lodging body 203. The first lodging body 201, the second lodging body 202 and the third lodging body 203 includes, but does not limit to, the same number of the hooks 22 and may also have different number of the hooks 22. While closing the loose leaf binder of the fourth embodiment, the plurality of loose leaves 33 are at the same axis, and the covering portions 6 cover the plurality of loose leaves 33 (as shown in FIG. 16).

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A retaining assembly of a binder comprising:
a layering comprising clip notchs on two sides thereof respectively; and
at least one lodging body lodged on the layering, each of the at least one lodging body comprising a connection piece, a plurality of hooks and a plurality of hook pieces, the connection piece connected to the plurality of hooks, the connection piece formed by bending one end of the plurality of hooks to an angle, the hook piece formed by bending the other end of each of the plurality of hook to the angle, the plurality of hooks are equally spaced;
wherein, when each of the plurality of hook pieces passes through a plurality of through holes of a loose leaf binder, the plurality of through holes are respectively disposed on the plurality of hooks, and when the connection piece and the plurality of hook pieces are lodged in the corresponding clip notches, the loose leaf binder is positioned on the at least one lodging body.

2. The retaining assembly of the binder as recited in claim 1, wherein the connection piece comprises a bump, and the lodging body is positioned on the layering through lodging the bump into the clip notchs.

3. The retaining assembly of the binder as recited in claim 1, wherein the loose leaf binder comprises a front cover, a back cover and a plurality of loose leaves, and the plurality of loose leaves are located between the front cover and the back cover, and the plurality of through holes are respectively disposed at one side of the front cover, the back cover and the plurality of loose leaves, and the plurality of through holes respectively correspond to the plurality of hooks, and an equal distance between each of the plurality of hooks is 5 millimeter to 8.9 millimeter, 8.9 millimeter to 9.8 millimeter, or 9.8 millimeter to 1000 millimeter.

4. The retaining assembly of the binder as recited in claim 3, wherein each of the front cover, each of the back cover or each set of the plurality of loose leaves are different sizes when the number of the loose leaf binders is more than one.

5. The retaining assembly of the binder as recited in claim 1, wherein the lodging body comprises a first lodging body and a second lodging body, and the first lodging body and the second lodging body have different number of the plurality of hooks.

6. A retaining assembly of a binder comprising:
a layering, each of the layering comprising a plurality of guide rails, each of the plurality of guide rails comprising clip notchs on two sides respectively, the plurality of guide rails arranged abreast with each other; and
a plurality of lodging bodies lodged in the layering, the lodging body comprising a connection piece, a plurality of hooks and a plurality of hook pieces, the connection piece formed by bending ends of each of the plurality of hooks to reach an angle, the plurality of hook piece formed by bending the other end of each of the plurality of hooks to reach the angle;
wherein the plurality of hooks are equally spaced; each of the plurality of hook pieces passes through a plurality of through holes of a plurality of loose leaf binders so that the plurality of through holes are respectively disposed on each hook, and when the connection piece and the plurality of hook pieces are lodged in the corresponding clip notches, the plurality of loose leaf binders are respectively disposed on the plurality of lodging bodies.

7. The retaining assembly of the binder as recited in claim 6, wherein the connection piece comprises a bump, and the lodging body is positioned on the layering through lodging the bump into the clip notchs.

8. The retaining assembly of the binder as recited in claim 6, wherein the loose leaf binder comprises a front cover, a back cover and a plurality of loose leaves, and the plurality of loose leaves are located between the front cover and the back cover, and the plurality of through holes are respectively disposed at one side of the front cover, the back cover and the plurality of loose leaves, and the plurality of through holes respectively correspond to the plurality of hooks, and an equal distance between each of the plurality of the hooks is 5 millimeter to 8.9 millimeter, 8.9 millimeter to 9.8 millimeter, or 9.8 millimeter to 1000 millimeter.

9. The retaining assembly of the binder as recited in claim 8, wherein each of the front cover, each of the back cover or each set of the plurality of loose leaves are different sizes.

10. The retaining assembly of the binder as recited in claim 6, wherein the lodging body comprises a first lodging body and a second lodging body, and the first lodging body and the second lodging body have different number of the plurality of hooks.

11. A retaining assembly of a binder comprising:
a front cover structure further comprising:
a covering portion;
a layering disposed on a surface of the covering portion; and
at least one lodging body lodged on the layering, the at least one lodging body comprising a connection piece, a plurality of hooks and a plurality of hook pieces, the connection piece connected to the plurality of hooks, the connection piece formed by bending ends of the plurality of hooks to reach an angle, the plurality of hook pieces formed by bending the other end of each of the plurality of hooks to reach the angle, the plurality of hooks are equally spaced, and the plurality of hook pieces and the connection piece are at a same horizontal plane;
wherein the covering portion is bent toward directions of the layering and the lodging body along two sides of where the lodging body is lodged on the layering.

12. The retaining assembly of the binder as recited in claim 11, further comprising a plurality of loose leaves, wherein each of the plurality of hook pieces passes through a plurality of through holes of the plurality of loose leaves so that the plurality of through holes are respectively disposed on each of the plurality of hooks, and when the connection piece and the plurality of hook pieces are lodged to the corresponding layering, the plurality of loose leaves are positioned on the lodging body, and the covering portion covers the layering, the lodging body and the plurality of loose leaves.

13. The retaining assembly of the binder as recited in claim 11, wherein the plurality of through holes are disposed on one side of the plurality of loose leaves, and the plurality of through holes respectively correspond to the plurality of hooks.

14. The retaining assembly of the binder as recited in claim 11, wherein two sides of the layering are provided with a clip notch respectively, and the connection piece and the plurality of hook pieces are respectively lodged in each of the clip notch.

15. The retaining assembly of the binder as recited in claim 14, wherein the connection piece comprises a bump, and the lodging body is positioned on the layering through lodging the bump in the clip notch.

16. The retaining assembly of the binder as recited in claim 15, wherein the layering is a strip, the layering is combined with the covering portion, and lodging slots are respectively formed on two sides of a joint portion of the layering and the covering portion, and the lodging slots are respectively lodged with the connection piece and the plurality of hook pieces.

17. The retaining assembly of the binder as recited in claim 16, wherein the bump is lodged in the lodging slots to position the lodging body on the layering.

18. The retaining assembly of the binder as recited in claim 11, wherein an equal distance between each of the plurality of the hooks is 5 millimeter to 8.9 millimeter, 8.9 millimeter to 9.8 millimeter, or 9.8 millimeter to 1000 millimeter.

19. The retaining assembly of the binder as recited in claim 11, wherein the layering and the covering portion are connected by adhesion, sewing, nailing or bolting.

20. The retaining assembly of the binder as recited in claim 11, wherein the lodging body comprises a first lodging body and a second lodging body, and the first lodging body and the second lodging body comprises different number of the hooks.
